(19) United States
(12) Patent Application Publication
(10) Pub. No.: US 2012/0149383 A1
(43) Pub. Date: Jun. 14, 2012

(54) COMMUNICATION METHOD AND COMMUNICATION DEVICE USING THE SAME

(75) Inventors: Guotong Wang, Beijing (CN); Anthony Lee, San Diego, CA (US)

(73) Assignee: VIA TELECOM, INC., San Diego, CA (US)

(21) Appl. No.: 13/325,184

(22) Filed: Dec. 14, 2011

Related U.S. Application Data
(60) Provisional application No. 61/423,048, filed on Dec. 14, 2010.
(60) Provisional application No. 61/423,056, filed on Dec. 14, 2010.

(51) Int. Cl. H04W 8/02; H04W 68/00; H04W 72/04; H04W 64/00

(52) U.S. Cl. 455/450; 455/456.1

(57) ABSTRACT

A communication method and a communication device using the same method are proposed. The proposed communication method is adapted to a machine-to-machine communication device (M2M device) with low mobility, and includes following steps: reporting that the M2M device is low mobility to a communication network; reporting a sector, in which the M2M device is located, to the communication network; and transmitting a paging message only in the sector to the M2M device.

### BACKGROUND

1. Field of the Invention

The invention relates to a communication method and a communication device using the same method, and, particularly, the communication method is adapted to Machine to Machine (M2M) communications device with low mobility.

2. Description of Related Art

Machine to Machine (M2M) communications (also called machine-type-communication, abbreviated as MTC) is a very distinct capability that enables the implementation of the “Internet of things”. It is defined as information exchange between a subscriber station (or a wireless communication device) and a M2M server in the core network (through a base station) or just between subscriber stations, which may be carried out without any human interaction.

M2M communications allow both wireless communication devices and wired communication devices to communicate with other devices of the same ability. M2M communications can use a device (such as a sensor or a meter) to capture an event (such as temperature, inventory level, etc.), which is relayed through a network (wireless, wired or hybrid) to an application server (M2M server), that translates the captured event into meaningful information (for example, items need to be restocked) to the subscriber user.

FIG. 1 illustrates an overall M2M communication network architecture. Referring to FIG. 1, an M2M communication network 10 may include a plurality of wireless communication devices of M2M applications (referred as M2M devices) 101, 102, 103, . . . , 10n, a communication network 120, at least an M2M server 130, and at least an M2M subscriber 140. The M2M devices 101, 102, 103, . . . , 10n are connected to the M2M server 130 through the communication network 120 (which can be a wireless communication network, a wired network or a hybrid of wireless and wired communication network). The M2M subscriber 140 is connected to the M2M server 130, and obtains information from the M2M server 130 through application programming interface (API), where the information is transmitted from M2M devices 101, 102, 103, . . . , 10n to the M2M server 130.

M2M devices are usually of “low mobility”, which means that some M2M devices are usually static, such as metering, pipeline monitoring applications. However, “low mobility”is not a common feature for all M2M applications, for example, fleet management or taxi scheduling having M2M devices usually in movement. “Low mobility” may refer to not moving frequently and may move only within small area, such as health monitoring at home. “Low mobility” may also refer to not moving frequently and may move only within wide area, such as mobile sales terminals. Low mobility” may also refer to not moving normally, such as water metering with a fixed location. Since these M2M devices are of “low mobility”, it is a major concern to develop a new M2M communication method for low mobility M2M devices to access wireless communication network with reduced amount of mobility management and session management signalling.

### SUMMARY

The invention is directed to a communication method and a communication device using the same device, and the communication method is adapted to M2M devices with low mobility.

According to an embodiment, the invention provides a communication method, which is adapted to a machine-to-machine communication device (M2M device) with low mobility, and includes following steps: reporting that the M2M device is low mobility to a communication network; reporting a position, in which the M2M device is located, to the communication network; and transmitting a paging message only in the position to the M2M device.

According to an embodiment, the invention provides a communication method, which is adapted to a M2M device with low mobility, and includes following steps: reporting that the M2M device is low mobility to a communication network; broadcasting, at the communication network, pre-defined resource allocation for the low mobility M2M devices; and transmitting data over the pre-defined resource to the communication network.

According to an embodiment, the invention provides a communication device. The communication device includes a transceiver and a communication protocol module. The transceiver is configured for transmitting signals to and receiving signals from a communication network. The communication protocol module is connected to the transceiver, and is configured for reporting that the M2M device is low mobility to a communication network, reporting a position, in which the M2M device is located, to the communication network, and receiving a paging message only in the position from the communication network

According to an embodiment, the invention provides a communication device. The communication device includes a transceiver and a communication protocol module. The transceiver is configured for transmitting signals to and receiving signals from a communication network. The communication protocol module is connected to the transceiver, and is configured for reporting that the M2M device is low mobility to a communication network; receiving pre-defined resource allocation for the low mobility M2M devices from the communication network, and transmitting data over the pre-defined resource to the communication network.

Based upon the aforementioned descriptions, according to the aforementioned embodiments of the invention, there are proposed communication methods and communication devices using the same methods. Through reporting the M2M device is low mobility to the communication network, signalling associated with mobility management and session management can be greatly reduced both at M2M devices and the communication network, in response to low mobility status of the M2M device.

Several embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an overall M2M communication network architecture.

FIG. 2 is a functional block diagram illustrating a wireless communication device according to an exemplary embodiment of the invention.

FIG. 3 is a flowchart illustrating a method for reporting low mobility according to an exemplary embodiment of the invention.

FIG. 4 is a flowchart illustrating another method for reporting low mobility according to an exemplary embodiment of the invention.

FIG. 5 is a flowchart illustrating a communication method according to an exemplary embodiment of the invention.

FIG. 6 is a flowchart illustrating another communication method according to an exemplary embodiment of the invention.

FIG. 7 is a flowchart illustrating another communication method according to an exemplary embodiment of the invention.

### DETAILED DESCRIPTION OF DISCLOSED EMBODIMENTS

The invention provides several embodiments which describes communication methods and communication devices using the same methods. The proposed communication methods are adapted to M2M devices with low mobility. The proposed communication devices refer to the M2M devices in the present disclosure.

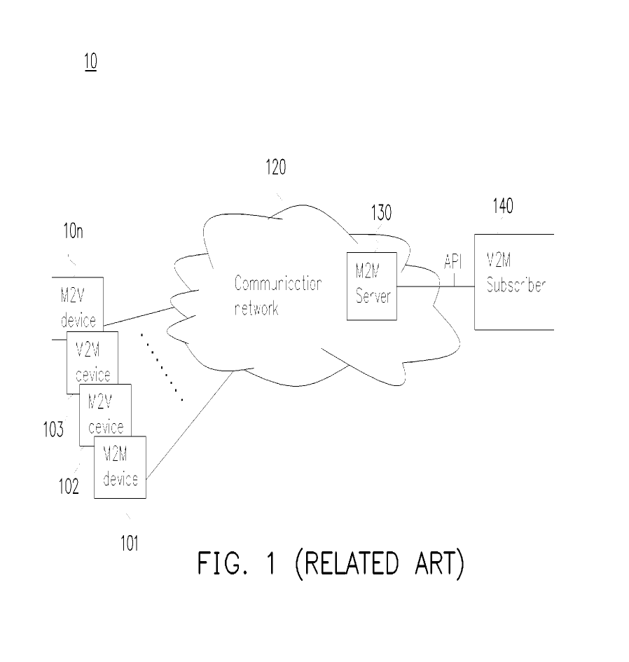

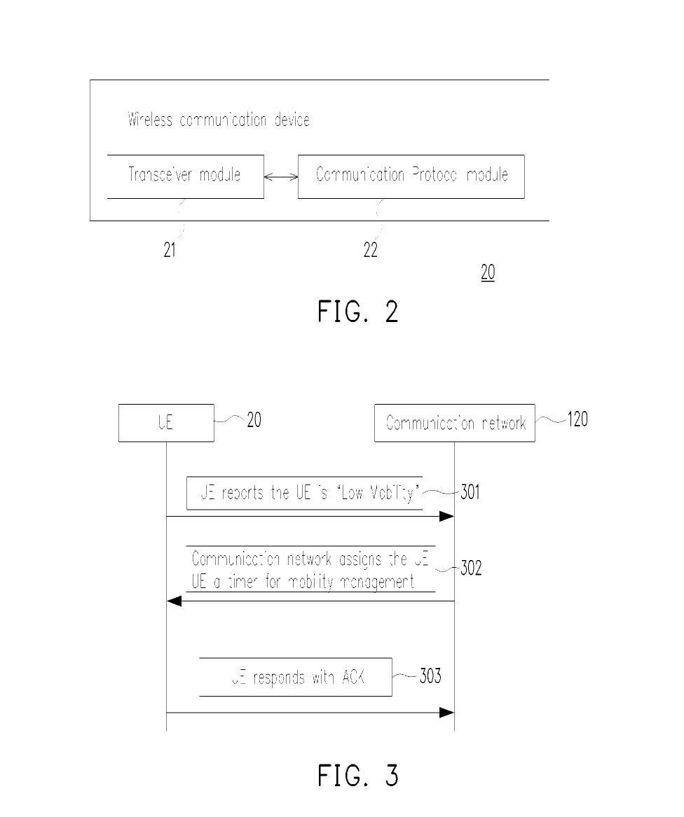

FIG. 2 is a functional block diagram illustrating a wireless communication device according to an exemplary embodiment of the invention. Referring to FIG. 1 and FIG. 2, the wireless communication device 20 can be one of the M2M devices 101, 102, 103, . . . , 10n. In other context, the wireless communication device 20 can be called a user equipment (UE), a mobile station, or an advanced mobile station. The wireless communication device 20 includes a transceiver module 21 and a communication protocol module 22. The transceiver module 21 is configured for receiving radio signals from the communication network 120 and transmitting radio signals to the communication network 120. As mentioned previously, the communication network 120 can be a wireless communication network, a wired network or a hybrid of wireless and wired communication network. In practical implementation, the transceiver module 21 can be transceiver circuit which is connected to an antenna (not shown in FIG. 2) and configured for performing analog-to-digital signal conversion, digital-to-analog signal conversion, modulation, demodulation, signal amplification, low pass filtering, band pass filtering, and so forth. The transceiver module 21 provides the received message (converted from radio signals transmitting by the communication network 120) to the communication protocol module 22, modulates the message from communication protocol module 22 into modulated radio signals, and further transmits the modulated radio signals to the communication network 120.

The communication protocol module 22 is configured for reporting to the communication network 120 that it is low mobility (through transmitting a pre-defined indicator) through the transceiver module 21. The communication protocol module 22 is also configured for selecting one timer/timers assigned by the communication network 120 for mobility management. The communication protocol module 22 is also configured for selecting a proper timer value/timer values from timer values for different mobility levels broadcasted by the communication network 120. The communication protocol module 22 is also configured for reporting the sector/cell or other position of the device in which it is currently located to the communication network 120 through the transceiver module 21. In addition, the communication protocol module 22 is also configured for transmitting data over allocated channel resource or pre-defined resource to the communication network 120 through the transceiver module 21. In practical implementation, the communication protocol module 22 can be a processor, such as a digital signal processor, or a general purpose processor with embedded instruction software code, embedded protocol stack software or embedded firmware, where when the embedded instruction software code, embedded protocol stack software or embedded firmware are executed by the communication protocol module 22, the aforementioned procedures as well as related procedures illustrated in following FIGS. 3-7 can be performed accordingly.

FIG. 3 is a flowchart illustrating a method for reporting low mobility according to an exemplary embodiment of the invention. The method for reporting low mobility illustrated in FIG. 3 is an explicit communication method for the M2M device (or the UE 20) reporting it's low mobility to the communication network 120.

Referring to FIG. 1, FIG. 2 and FIG. 3, the proposed method for reporting low mobility includes: the communication protocol module 22 of the UE 20 reports to the communication network 120 that the UE 20 is “low mobility” through the transceiver module 21 (step 301); the communication network 120 assigns the UE 20 a timer for mobility management (step 302); and the communication protocol module 22 of the UE 20 responds with an acknowledgment (ACK) to the communication network 120 through the transceiver module 21 after receiving the timer for mobility management (step 303).

In practical implementation, the step 301 can be seen as the UE 20 transmitting an indicator to the communication network 120 in non access stratum (NAS) layer, where the indicator explicitly shows that the UE 20 is “low mobility”. The indicator can be tied to M2M device (i.e., UE 20) or M2M applications (for which the UE 20 is deployed). Also, the indicator can be configured during manufacturing phase, configured in subscription phase or determined by the UE 20 according to radio measurements obtained at the UE 20.

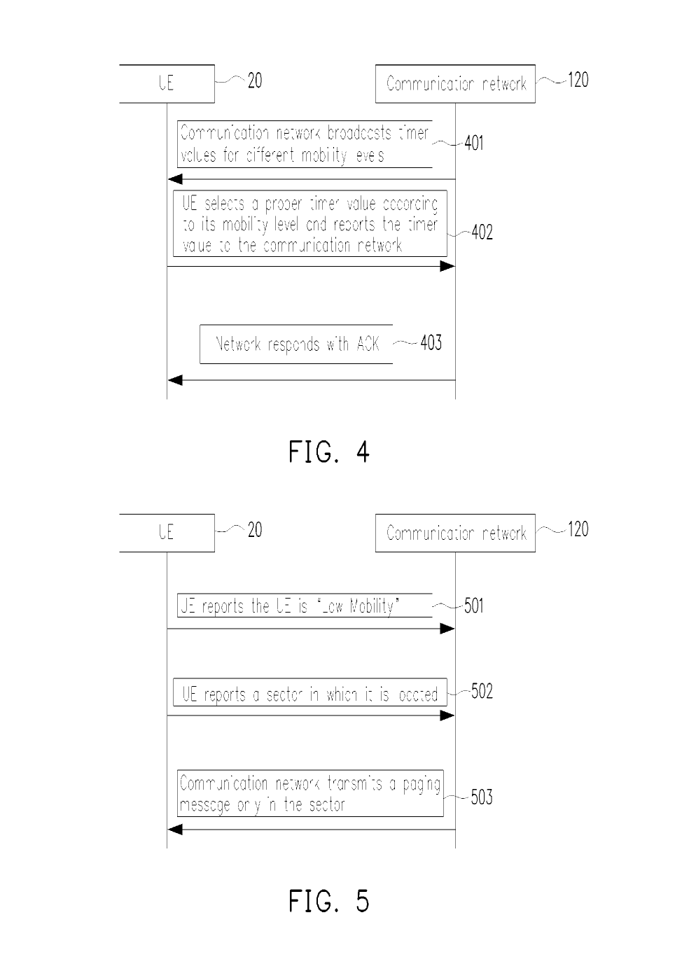

From other perspectives, the timer for mobility management described in the step 302 can be used by the communication protocol module 22 to perform location area update (LAU), tracking area update (TAU), routing area update (RAU) and so forth. Through using loner timer value for mobility management, the UE 20 can perform less frequent mobility procedures. Also, in the step 302, the communication protocol module 22 of the UE 20 receives a timer for mobility management assigned by the communication network 120. It is noted that the communication network 120 can include base stations, a network controller, a mobility management entity, and a data packet router which, in collaboration, can achieve the aforementioned procedures being executed at the communication network 120. The similar concept described here for the communication network 120 can be applied to all following embodiments illustrated in FIG. 4 to FIG. 7.

FIG. 4 is a flowchart illustrating another method for reporting low mobility according to an exemplary embodiment of the invention. The method for reporting low mobility illustrated in FIG. 4 is an implicit communication method for the UE 20 reporting that it is low mobility to the communication network 120.

Referring to FIG. 1, FIG. 2 and FIG. 4, the proposed method for reporting low mobility includes: the communication network 120 broadcasts a plurality of timer values for different mobility levels to the UE 20 (step 401); the communication protocol module 22 of the UE 20 selects a proper time value according to its mobility level and reports the selected timer value to the communication network 120 through the transceiver module 21 after receiving the broadcasted timer values for different mobility levels (step 402); and the communication network 120 responds with an ACK to the UE 20 after receiving the selected timer value from the UE 20 (step 403).

From other perspectives, the timers for different mobility levels described in the step 401 can be used by the communication protocol module 22 to perform LAU, TAU, RAU and so forth. Also, in the step 401, the communication protocol module 22 of the UE 20 receives timer values for different mobility levels from the communication network 120 through the transceiver module 21. In the step 403, the communication protocol module 22 of the UE 20 receives the ACK from the communication network 120 through the transceiver module 21.

FIG. 5 is a flowchart illustrating a communication method according to an exemplary embodiment of the invention. The communication method illustrated in FIG. 5 is a paging optimization process for a mobile-terminated (MT) scenario of the UE 20.

Referring to FIG. 1, FIG. 2 and FIG. 5, the proposed communication method includes: the communication protocol module 22 of the UE 20 reports that the UE 20 is “low mobility” to the communication network 120 through the transceiver module 21 (step 501); the communication protocol module 22 of the UE 20 reports a sector, in which the UE 20 is currently located, to the communication network 120 through the transceiver module 21 (step 502); and the communication network 120 transmits a paging message to the UE 20 only in the sector reported previously by the UE 20 (step 503).

From other perspectives, in the step 503, the communication protocol module 22 of the UE 20 receives the paging message only in the sector reported previously by the UE 20. Since the low mobility M2M device rarely changes its location, the amount of paging messages can be greatly reduced and the signalling overhead can be decreased by the communication method illustrated in FIG. 5. Also, in other embodiments, the step 501 can be implemented by the method for reporting low mobility illustrated in FIG. 3 or FIG. 4, whose technical details are not repeated herein. Alternatively, in yet other embodiments, the procedures in the method for reporting low mobility illustrated in FIG. 3 or FIG. 4 can be executed after the step 501 and before the step 502.

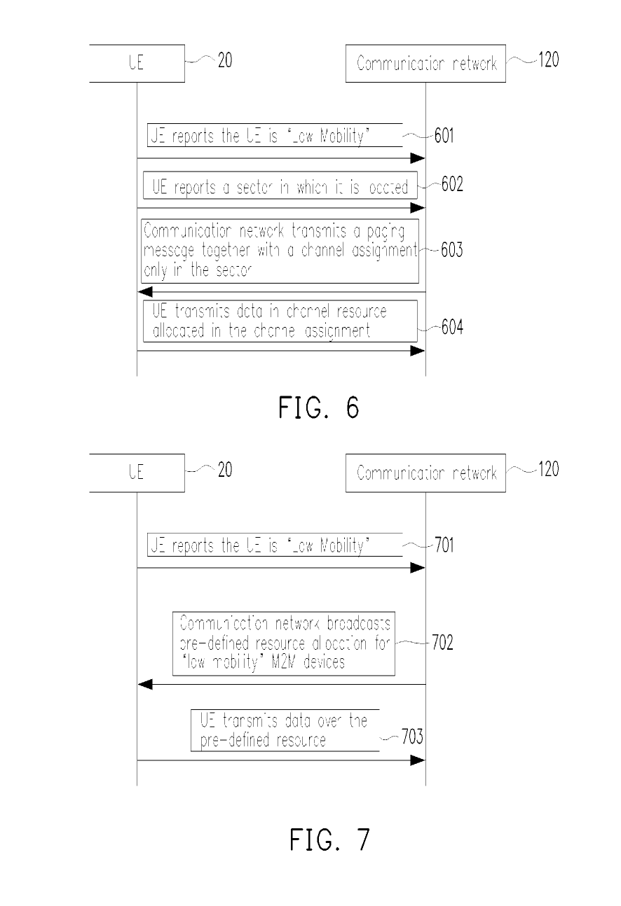

FIG. 6 is a flowchart illustrating another communication method according to an exemplary embodiment of the invention. The communication method illustrated in FIG. 6 is a direct channel assignment process for a MT scenario of the UE 20.

Referring to FIG. 1, FIG. 2 and FIG. 6, the proposed communication method includes: the communication protocol module 22 of the UE 20 reports that the UE 20 is “low mobility” to the communication network 120 through the transceiver module 21 (step 601); the communication protocol module 22 of the UE 20 reports a sector, in which the UE 20 is currently located, to the communication network 120 through the transceiver module 21 (step 602); the communication network 120 transmits a paging message together with a channel assignment to the UE 20 only in the sector reported previously by the UE 20 (step 603); and the communication protocol module 22 of the UE 20 transmits data in channel resource allocated in the channel assignment to the communication network 120 through the transceiver module 21 (step 604).

From other perspectives, in the step 603, the communication protocol module 22 of the UE 20 receives the paging message with the channel assignment only in the sector reported previously by the UE 20. Since the low mobility M2M device rarely changes its location, the assignment can be pre-defined, broadcasted by the communication network 120, or carried by the paging message. As such, the amount of paging messages can be greatly reduced and the signalling overhead can be decreased by the communication method illustrated in FIG. 6. The paging response procedures can also be omitted in the communication method illustrated in FIG. 6, which can further lead to reduced signalling overhead. Also, in other embodiments, the step 601 can be implemented by the method for reporting low mobility illustrated in FIG. 3 or FIG. 4, whose technical details are not repeated herein. Alternatively, in yet other embodiments, the procedures in the method for reporting low mobility illustrated in FIG. 3 or FIG. 4 can be executed after the step 601 and before the step 602.

FIG. 7 is a flowchart illustrating another communication method according to an exemplary embodiment of the invention. The communication method illustrated in FIG. 7 is a static resource assignment process for a mobile-oriented (MO) scenario of the UE 20.

Referring to FIG. 1, FIG. 2 and FIG. 7, the proposed communication method includes: the communication protocol module 22 of the UE 20 reports that the UE 20 is “low mobility” to the communication network 120 through the transceiver module 21 (step 701); the communication network 120 broadcasts pre-defined resource allocation for “low mobility” M2M devices to the UE 20 (step 702); and the communication protocol module 22 of the UE 20 transmits data over the pre-defined resource to the communication network 120 through the transceiver module 21 (step 703).

From other perspectives, in the step 702, the communication protocol module 22 of the UE 20 receives the pre-defined resource allocation for “low mobility” M2M devices, which is broadcasted by the communication network 120. Since the communication network 120, a base station or an eNB knows that a low mobility M2M device always in its coverage, the static resource assignment can be pre-defined or broadcasted, which reduces scheduling related signalling overhead. Also, the proposed communication method illustrated in FIG. 7 can be helpful when the M2M device is required to transmit data frequently in certain periods such as meter which needs to report its measurement results to its M2M server every ten minutes (i.e., scheduled and static transmission pattern). In addition, in other embodiments, the step 701 can be implemented by the method for reporting low mobility illustrated in FIG. 3 or FIG. 4, whose technical details are not repeated herein. Alternatively, in yet other embodiments, the procedures in the method for reporting low mobility illustrated in FIG. 3 or FIG. 4 can be executed after the step 701 and before the step 702.

Further, for the communication methods illustrated in FIGS. 5-7, the Doppler effect for the M2M device (the UE 20) are minor for low mobility M2M devices so the related processing on mitigating Doppler effect can be simplified. Also, multiple-input-multiple-output (MIMO) related processing can be simplified by selecting single-input-single-output (SISO) configuration since the amount of data transmitted from each one of M2M devices is always little.

In summary, the embodiments of the present invention provide communication methods and communication devices using the same methods. Through reporting the M2M device is low mobility to the communication network, assigning or broadcasting related parameters in the sector in which the M2M device is currently located or implicitly assigning or reporting parameters, signalling associated with mobility management and session management can be greatly reduced both at M2M devices and the communication network.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A communication method, adapted to a machine-to-machine communication device (M2M device) with low mobility, comprising the steps of:
reporting that the M2M device is low mobility to a communication network;
reporting a position, in which the M2M device is located, to the communication network; and
transmitting a paging message only in the position to the M2M device.

2. The communication method according to claim 1, wherein the step of transmitting the paging message comprises:
transmitting the paging message together with a channel assignment only in the position to the M2M device.

3. The communication method according to claim 2, wherein after the step of transmitting the paging message together with the channel assignment, the communication method further comprises:
transmitting data, in channel resource allocated in the channel assignment, to the communication network.

4. The communication method according to claim 1, wherein after the step of reporting that the M2M device is low mobility, the communication method further comprises:
assigning the M2M device a timer for mobility after receiving the report that the M2M device is low mobility; and
responding with acknowledgment to the communication network.

5. The communication method according to claim 1, wherein after the step of reporting that the M2M device is low mobility, the communication method further comprises:
broadcasting, at the communication network, timer values for different mobility levels after receiving the report that the M2M device is low mobility;
selecting, at the M2M device, a proper timer value according to the mobility level thereof;
reporting the selected time value to the communication network; and
responding with acknowledgment to the M2M device.

6. A communication method, adapted to a machine-to-machine communication device (M2M device) with low mobility, comprising the steps of:
reporting that the M2M device is low mobility to a communication network;
broadcasting, at the communication network, pre-defined resource allocation for the low mobility M2M devices; and
transmitting data over the pre-defined resource to the communication network.

7. The communication method according to claim 6, after the step of reporting that the M2M device is low mobility, the communication method further comprises:
assigning the M2M device a timer for mobility after receiving the report that the M2M device is low mobility; and
responding with acknowledgment to the communication network.

8. communication method according to claim 6, after the step of reporting that the M2M device is low mobility, the communication method further comprises:
broadcasting, at the communication network, timer values for different mobility levels after receiving a report that the M2M device is low mobility;
selecting, at the M2M device, a proper timer value according to the mobility level thereof;
reporting the selected time value to the communication network; and
responding with acknowledgment to the M2M device.

9. A communication device, comprising:
a transceiver, configured for transmitting signals to and receiving signals from a communication network; and
a communication protocol module, connected to the transceiver, configured for reporting that the M2M device is low mobility to a communication network, reporting a position, in which the M2M device is located, to the communication network, and receiving a paging message only in the position from the communication network.

10. The communication device according to claim 9, wherein the communication protocol module is further configured for receiving the paging message together with a channel assignment only in the position from the communication network.

11. The communication device according to claim 10, wherein, after receiving the paging message together with the channel assignment, the communication protocol module is further configured for transmitting data, in channel resource allocated in the channel assignment, to the communication network.

12. The communication device according to claim 9, wherein, after reporting that the M2M device is low mobility, the communication protocol module is further configured for receiving a timer for mobility assigned by the communication network and responding with acknowledgment to the communication network.

13. The channel switching method according to claim 9, wherein, after reporting that the M2M device is low mobility, the communication protocol module is further configured for receiving timer values for different mobility levels from the communication network, selecting a proper timer value according to the mobility level thereof, and reporting the selected timer value to the communication network.

14. A communication device, comprising:
a transceiver, configured for transmitting signals to and receiving signals from a communication network; and
a communication protocol module, connected to the transceiver, configured for reporting that the M2M device is low mobility to a communication network; receiving pre-defined resource allocation for the low mobility M2M devices from the communication network, and transmitting data over the pre-defined resource to the communication network.

15. The communication device according to claim 14, wherein after reporting that the M2M device is low mobility, the communication protocol module is further configured for receiving a timer for mobility assigned by the communication network, and responding with acknowledgment to the communication network.

16. The communication device according to claim 14, wherein after reporting that the M2M device is low mobility, the communication protocol module is further configured for receiving timer values for different mobility levels broadcasted by the communication network, selecting a proper timer value according to the mobility level thereof, and reporting the selected timer value to the communication network.
